(19) United States
(12) Patent Application Publication
(10) Pub. No.: US 2020/0033845 A1
(43) Pub. Date: Jan. 30, 2020

(54) METHOD AND APPARATUS FOR CONTROLLING BY EMERGENCY STEP IN AUTONOMOUS DRIVING SYSTEM

(71) Applicant: LG ELECTRONICS INC., Seoul (KR)

(72) Inventor: Yongsoo PARK, Seoul (KR)

(21) Appl. No.: 16/588,335

(22) Filed: Sep. 30, 2019

(30) Foreign Application Priority Data
Aug. 26, 2019 (KR) 10-2019-0104702

(51) Int. Cl. G05D 1/00; G08G 1/16

(52) U.S. Cl. CPC G05D 1/0011; G08G 1/164; H04W 4/44; G05D 1/0055; G05D 1/0088

(57) ABSTRACT

An aspect of the present disclosure, in a method for controlling by an emergency step, the method senses an object through a sensor; determines an emergency step related the object based on at least one of a distance with the object, a collision estimation time with the object, and an appearance event of the object; and transmits, to a server, sensing data related to the object based on the emergency step. Through the method, the server may control quickly the vehicle based on the emergency step determined in the vehicle. At least one of an autonomous vehicle, a user terminal and a server of the present disclosure may be associated with an artificial intelligence module, a drone (Unmanned Aerial Vehicle, UAV) robot, augmented reality (AR) device, virtual reality (VR)) device, a device related to a 5G service, and the like.

### CROSS-REFERENCE TO RELATED APPLICATION

This application claims the benefit of Korean Patent Application No. 10-2019-0104702 filed on Aug. 26, 2019. The contents of this application are hereby incorporated by reference in its entirety.

### BACKGROUND OF THE INVENTION

### Field of the Invention

The present disclosure relates to an autonomous driving system, and a method for controlling by an emergency step determined based on sensing data generated in a vehicle, and an apparatus for the same.

### Related Art

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

An object of the present disclosure is to propose a method of controlling by an emergency step and an apparatus for the same.

In addition, an object of the present disclosure is to propose a method for controlling a server by an emergency step determined based on sensing data generated in a vehicle, and an apparatus for the same.

It will be appreciated by persons skilled in the art that the objects that could be achieved with the present disclosure are not limited to what has been particularly described hereinabove and other objects that are not mentioned will be clearly understood by those skilled in the art from the following detailed description.

An aspect of the present disclosure comprises the step of sensing an object through a sensor; determining an emergency step related the object based on at least one of a distance with the object, a collision estimation time with the object, and an appearance event of the object; and transmitting, to a server, sensing data related to the object based on the emergency step, wherein the vehicle may be remotely controlled through the server, and the appearance event may be to indicate that the object is an object not sensed for a predetermined time in the sensor

Further, the emergency step may be classified based on the degree of attention required related to the object, and may comprise the step of indicating that the vehicle should immediately perform a control operation relating to the object

Further, when the emergency step indicates that the vehicle should immediately perform the control operation, the sensing data may be composed of location information of the object and information of the emergency step.

Further, the method may further comprise the steps of receiving, from the server, a control message; and performing a control operation based on the control message, and wherein the control message may be generated based on the information of the emergency step in the server.

Another aspect of the present disclosure comprise the steps of receiving, from a vehicle, sensing data related to an object; performing an algorithm for detecting the object based on the sensing data; generating a control message based on the algorithm; and transmitting, to the vehicle, the control message, wherein the server may remotely control the vehicle, and the sensing data may include information of an emergency step, the emergency step may be configured in the vehicle and classified based on the degree of attention required related to the object.

Further, the algorithm may include object detection, object classification, object tracking or object behavior prediction.

Further, the emergency step may include the step of indicating that a control operation associated with the object should be performed in the vehicle or indicating that the control operation should be performed immediately in the vehicle.

Further, the method may further comprise the step of verifying the emergency step based on stored sensing data or sensing data generated from another sensor, wherein when the verification fails, all of the algorithms may be performed.

Further, when the information of the emergency step indicates that the control operation associated with the object should be performed in the vehicle, the algorithm is that the object detection, the object classification, the object tracking and the object behavior prediction may be performed.

Further, the object detection may be to detect the object only.

Further, when the information of the emergency step indicates that the control operation should be immediately performed in the vehicle, the algorithm is that the object detection may be performed.

Further, the control message may be for causing the control operation to be immediately performed in the vehicle.

Another aspect of the present disclosure, in a server for performing by an emergency step in the autonomous driving system, comprising: a transceiver; a memory; and a processor, wherein the processor configured to: receive, from a vehicle, sensing data related to an object through the transceiver; perform an algorithm for detecting the object based on the sensing data; generate a control message based on the algorithm; and transmit, to the vehicle, the control message via the transceiver, wherein the server may remotely control the vehicle, and the sensing data may include information of an emergency step, the emergency step is configured in the vehicle and may be classified based on the degree of attention required related to the object.

According to an embodiment of the present disclosure, the server may control the vehicle by the emergency step.

In addition, according to an embodiment of the present disclosure, the server may control the vehicle by the emergency step determined based on the sensing data generated in the vehicle.

It will be appreciated by persons skilled in the art that the effects that could be achieved with the present disclosure are not limited to what has been particularly described hereinabove and other objects that are not mentioned will be clearly understood by those skilled in the art from the following detailed description.

### BRIEF DESCRIPTION OF THE DRAWINGS

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of an autonomous vehicle and a 5G network in a 5G communication system

FIG. 4 shows an example of a basic operation between vehicles using 5G communication.

FIG. 5 is a diagram showing a vehicle according to an embodiment of the present disclosure.

FIG. 6 is a control block diagram of the vehicle according to an embodiment of the present disclosure.

FIG. 7 is a control block diagram of the autonomous device according to an embodiment of the present disclosure.

FIG. 8 is a diagram showing a signal flow in an autonomous vehicle according to an embodiment of the present disclosure.

FIG. 9 is a diagram referred to in description of a usage scenario of a user according to an embodiment of the present disclosure.

FIG. 10 is an illustration of V2X communication to which the present disclosure may be applied.

FIGS. 11A and 11B illustrate a resource allocation method in sidelink in which V2X is used.

FIG. 12 is an example of object detection and tracking method to which the present disclosure can be applied.

FIG. 13 is an embodiment of a vehicle to which the present disclosure may be applied.

FIG. 14 is an embodiment of a server to which the present disclosure may be applied.

FIG. 15 is an embodiment where the emergency step to which the present disclosure may be applied is the first step.

FIG. 16 is an embodiment where the emergency step to which the present disclosure may be applied is the second step.

FIG. 17 is an embodiment where the emergency step to which the present disclosure may be applied is the third step.

FIG. 18 is an example of general apparatus to which the present disclosure can be applied.

The accompanying drawings, which are included as part of the detailed description in order to provide a thorough understanding of the present disclosure, provide examples of the present disclosure and together with the description, describe the technical features of the present disclosure.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

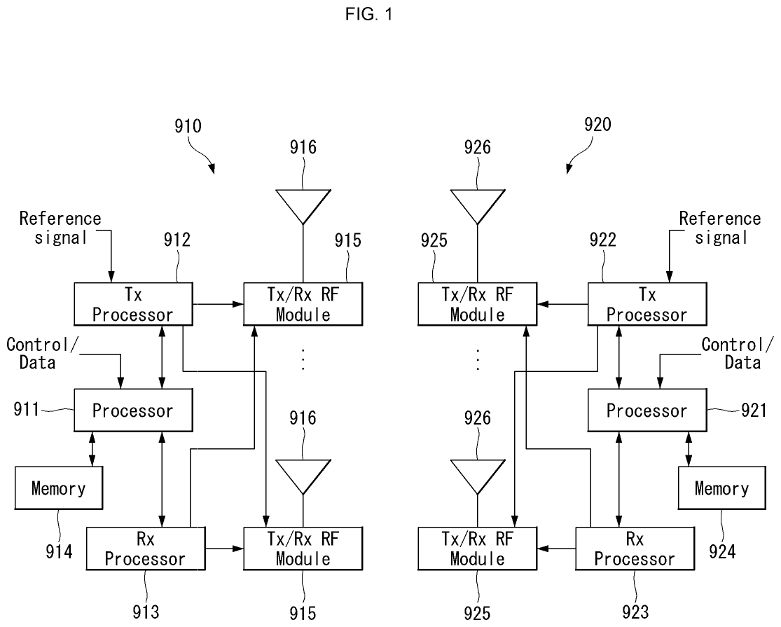

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

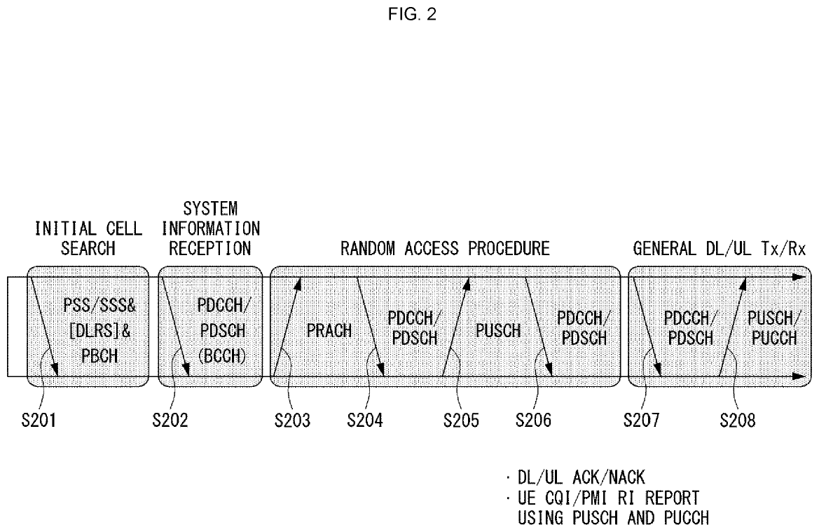

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

ABM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

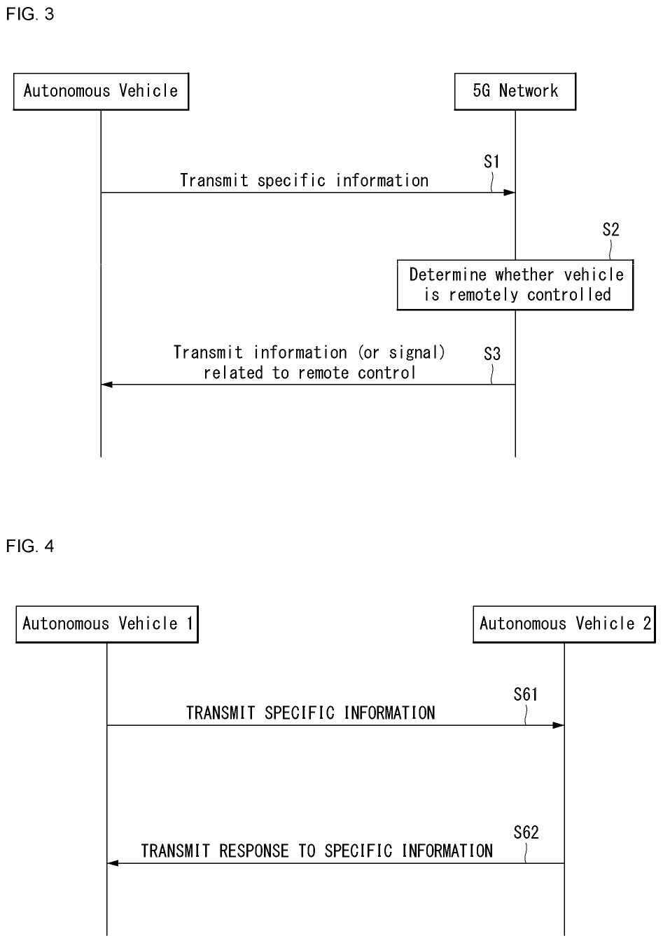

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

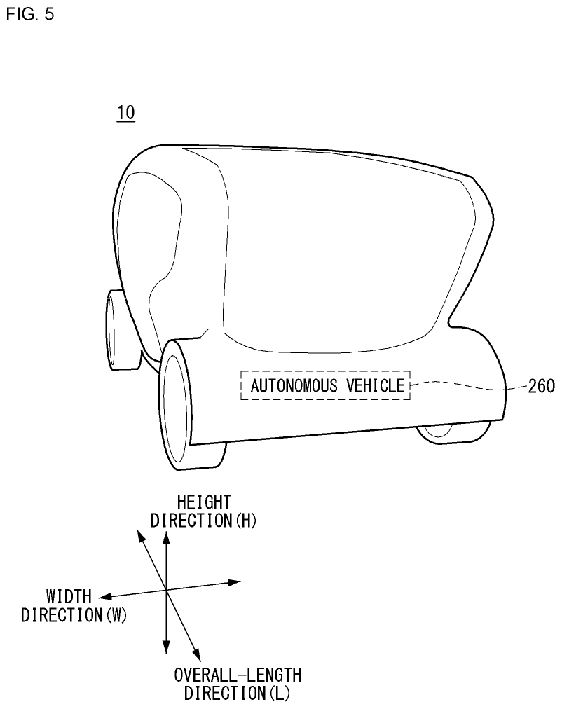

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

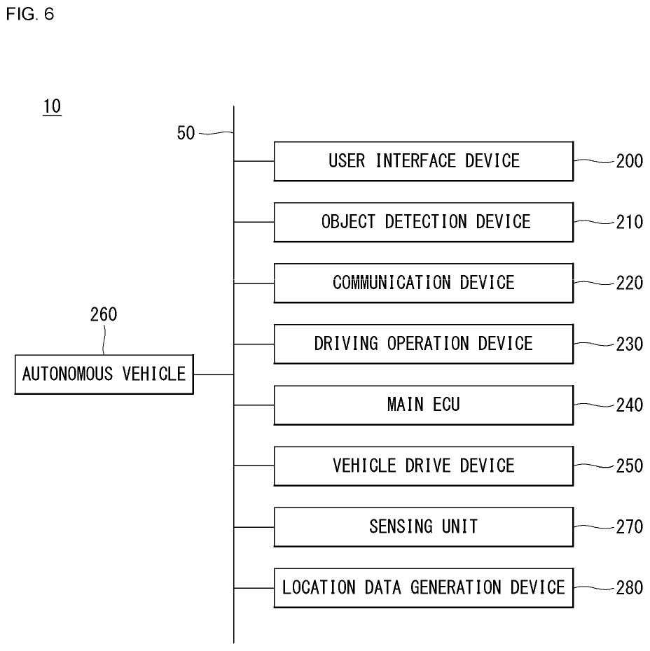

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

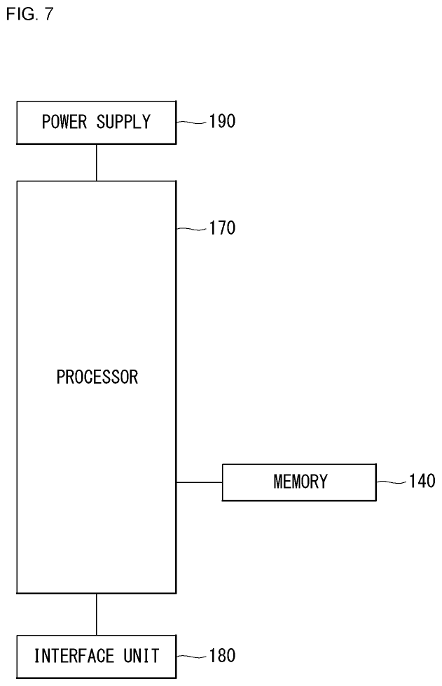

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

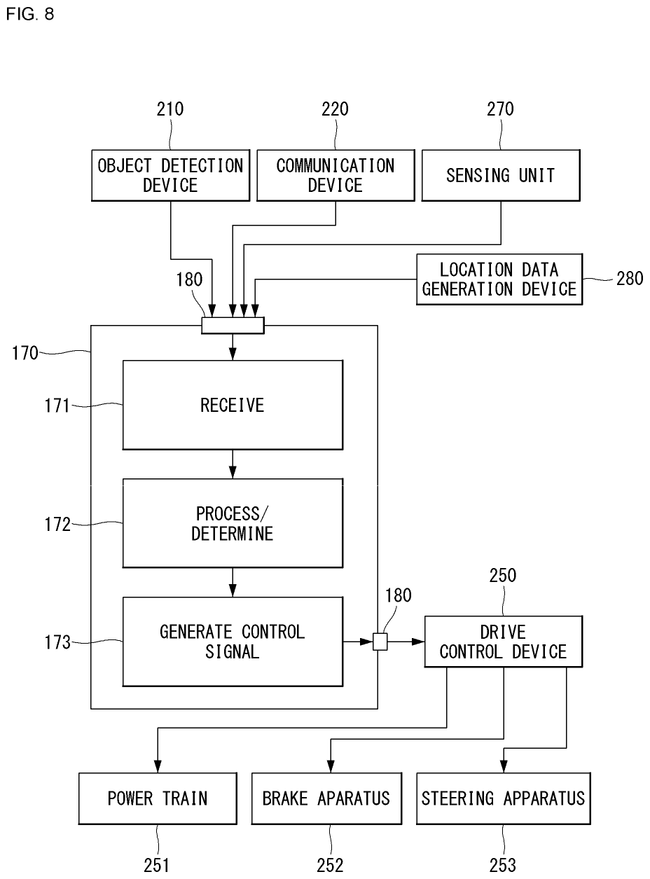

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Autonomous Vehicle Usage Scenarios

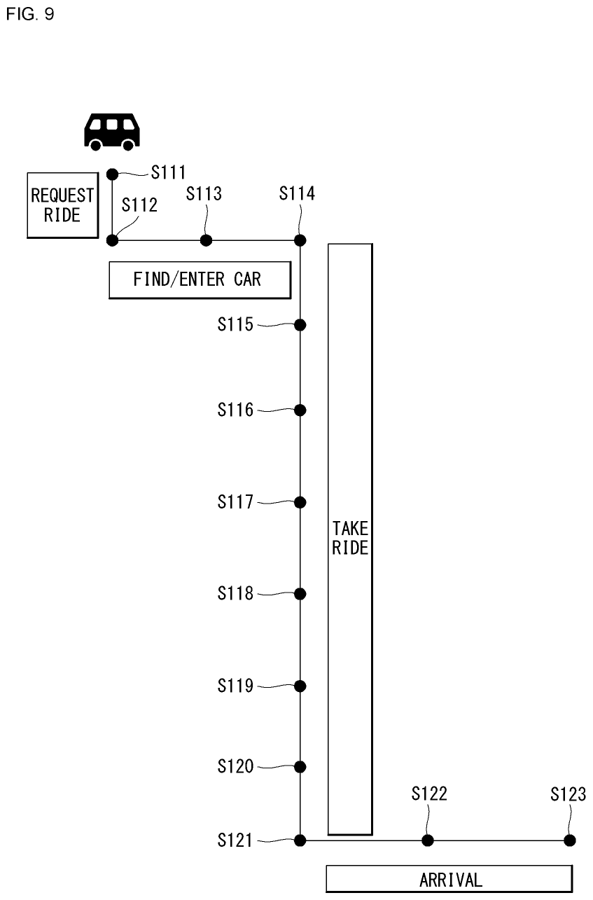

FIG. 9 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

FIG. 10 is an illustration of V2X communication to which the present disclosure may be applied.

V2X communication includes communication between the vehicle and all entities such as vehicle-to-vehicle (V2V), which refers to communication between vehicles, vehicle to infrastructure (V2I), which refers to communication between a vehicle and an eNB or road side unit (RSU), vehicle-to-pedestrian (V2P), which refers to communication between UEs carried by vehicle and individual (pedestrians, cyclists, vehicle drivers or passengers), vehicle-to-network (V2N), and the like.

V2X communication may indicate the same meaning as V2X sidelink or NR V2X or may indicate a broader meaning including the V2X sidelink or the NR V2X.

V2X communications may be applicable to various services such as, for example, front crash warnings, automatic parking systems, cooperative adaptive cruise control (CACC), loss of control warnings, traffic matrix warnings, traffic vulnerable safety warnings, emergency vehicle warnings and speed warning on curved roads, traffic flow control, and the like

V2X communication may be provided via a PC5 interface and/or a Uu interface. In this case, in a wireless communication system supporting V2X communication, specific network entities may exist for supporting communication between the vehicle and all entities. For example, the network entity may be a BS (eNB), a road side unit (RSU), a UE, an application server (e.g., a traffic safety server), or the like.

In addition, the UE performing V2X communication may mean not only a general handheld UE, but also a vehicle UE (V-UE (Vehicle UE)), a pedestrian UE (UE), an RSU of a BS type (eNB type), a RSU of a UE type, a robot having a communication module, or the like.

V2X communication may be performed directly between the UEs or via the network entity (entities). The V2X operation mode may be classified according to the method of performing the V2X communication.

V2X communication is required to support anonymity and privacy of UEs in the use of V2X applications such that operators or third parties cannot track UE identifiers within the region where V2X is supported.

Terms used frequently in V2X communication are defined as follows.
RSU (Road Side Unit): RSU is a V2X serviceable device that can transmit/receive with a mobile vehicle using V2I service. In addition, RSU is a fixed infrastructure entity that supports V2X applications and can exchange messages with other entities that support V2X applications. RSU is a commonly used term in the existing ITS specification, and the reason for introducing it in the 3GPP specification is to make the document easier to read in the ITS industry. An RSU is a logical entity that combines V2X application logic with the functionality of a BS (called a BS-type RSU) or a UE (called a UE-type RSU).
V2I Service: A type of V2X service, in which one party is a vehicle and the other party belongs to an infrastructure.
V2P service: A type of V2X service, in which one side is a vehicle and the other is a device carried by an individual (e.g., a portable UE device carried by a pedestrian, cyclist, driver or passenger).
V2X service: A type of 3GPP communication service that involves transmitting or receiving devices in a vehicle.
V2X enabled UE: UE that supports V2X service.
V2V service: A type of V2X service, both of which are vehicles.
V2V communication range: Direct communication range between two vehicles participating in V2V service.

There are four types of the V2X application, called Vehicle-to-Everything (V2X), such as (1) vehicle-to-vehicle (V2V), (2) vehicle-to-infrastructure (V2I), (3) vehicle-to-network (V2N), and (4) vehicle-to-pedestrians (V2P).

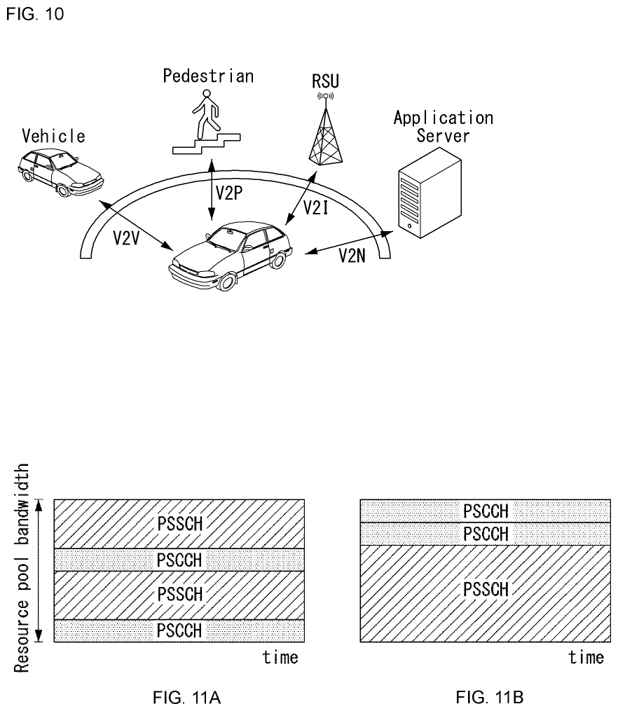

FIGS. 11A and 11B illustrate a resource allocation method in sidelink in which V2X is used.

In sidelinks, different sidelink control channels (PSCCHs) may be allocated spaced apart from each other in the frequency domain, and different sidelink shared channels (PSSCHs) may be allocated spaced apart from each other. Alternatively, different PSCCHs may be allocated in contiguous manner in the frequency domain, and PSSCHs may be allocated in contiguous manner in the frequency domain.

NR V2X

Support for V2V and V2X services in LTE was introduced to extend the 3GPP platform to the automotive industry during 3GPP releases 14 and 15.

Requirements for supporting the enhanced V2X use case are largely summarized into four use case groups.

(1) Vehicle Platooning allows vehicles to dynamically form a platoon that moves together. Every vehicle in platoon acquires information from the lead vehicle to manage the Platooning. This information allows the vehicle to drive more harmoniously than normal direction, go in the same direction and drive together.

(2) Extended sensors allows raw or processed data collected via local sensors or live video images from vehicles, road site units, pedestrian devices and V2X application servers to be exchanged. Vehicles can improve environmental awareness beyond what their sensors can detect, thereby providing a broader and more comprehensive view of local conditions. High data rate is one of the main features.

(3) Advanced driving enables semi-automatic or fully-automatic driving. Each vehicle and/or RSU shares its self-aware data acquired from local sensors with nearby vehicles, allowing the vehicle to synchronize and coordinate trajectory or manoeuvre. Each vehicle shares driving intent with a nearby driving vehicle.

(4) Remote driving allows a remote driver or V2X application to drive a remote vehicle for passengers who are unable to drive on their own or in a remote vehicle in a hazardous environment. When fluctuations are limited and the route can be predicted, such as public transportation, driving may be utilized based on cloud computing. High reliability and low latency are main requirements.

The above-described 5G communication technology may be applied in combination with the methods proposed in the present disclosure to be described later, or may be supplemented to specify or clarify the technical features of the methods proposed in the present disclosure.

Hereinafter, various embodiments of the present disclosure will be described in detail with reference to the accompanying drawings.

Object Detection and Tracking Method

The purpose of object detection is to keep track of the detection for the segmentation of the region of interest from the video image, and the situations for motion, positioning, and the like.

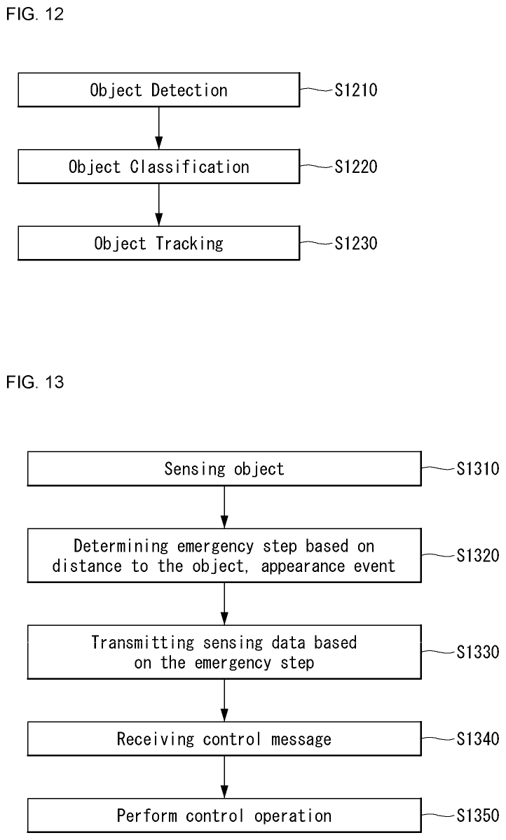

FIG. 12 is an example of object detection and tracking method to which the present disclosure can be applied.

The first thing in detecting an object is to recognize the region of interest. It is preferable to detect using the object detection algorithm, which is the best known in recognition of objects, but the detection process is difficult because there are many variables such as unknown objects, colors, and shapes. For this reason, most of the object detection and tracking methods perform the detection process through a fixed camera environment.

Object detection is the process of identifying objects of interest in cluster pixels and video sequences of objects. This may be done using various techniques such as frame differencing, optical flow, and background subtraction (S1210).

Objects may be classified as cars, birds, clouds, trees or other moving objects. Methods for classifying such objects include shape-based classification, motion-based classification, color based classification, texture based classification, and the like (S1220).

The tracking method may be a problem of finding an approximation of the path of an object on an image plane in a moving scene. In other words, when the object of interest in the image finds out how the moving path is similar to the previous frame and recognizes it as the same object, it may be to keep track of the object. Methods for tracking an object include point tracking, kernel tracking, silhouette and the like (S1230).

The autonomous vehicles that support existing remote driving transfer sensing data according to communication channel conditions and driving complexity. The server receives the sensing data, detects the object, classifies the object, and then keeps track of it. In addition, the operation in recognition of performing which further behavior and then prediction of the following situations should be done

In the case of driving a vehicle manually, a user may perform avoidance driving based on being only close to the vehicle when dangerous object is found. In general, the prediction for which state the dangerous object is in or how the object moves next in the avoidance driving is not taken into account.

When the avoidance driving is performed, after performing all the predictions for which state the dangerous object is or how the object moves in the autonomous vehicle, as it may take a relatively long time, there may be a risk that the control operation for the avoidance driving is performed late.

When only the efficiency is taken into consideration, the service provided by the autonomous vehicle may be limited.

In the present disclosure, the vehicle acquires the location information of the object in the object detection process through the sensing data. The vehicle determines the urgent degree according to the distance with the object and transmits only some data of the sensing data to the remote server first.

When the remote server receives data in which the emergency level is marked or finds out the emergency level (by determining the emergency level using the sensing data), the remote server performs functions such as object detection, classification, and tracking of the sensing data according to the emergency level, behavioral recognition and subsequent prediction of the object may be performed sequentially.

The vehicle may determine the control operation through the remote server, and may determine an acceleration/deceleration degree, a yaw rate degree, a user display degree of HMI, a message transmission type, and the like through V2X.

Through this, it is possible to quickly perform a remote control to respond to an emergency situation, and may be performed by dividing each step of the remote control as needed.

Determining Emergency Step

The emergency step may be determined in consideration of the relative speed of the object and the estimated time until the collision with the vehicle.

1. Method of Measuring Relative Velocity of Objects

In order to measure the relative velocity of an object, a successful frame image of the camera can be used. The instantaneous relative velocity v of the detected object, for example, may be calculated as shown in Equation 1.

$$v = \frac{Δ p}{Δ t} \qquad [ Equation 1 ]$$

ΔP means the spatial displacement of the object, and is the playback rate or frame capture rate of two consecutive video frames.

2. Estimated Time to Collision

In order to calculate the collision estimated time, it may be calculated such as Equation 2 using the relative distance D and the relative velocity v with the object detected by the camera, the radar, or the ridar.

$${T}_{c} = \frac{D}{v} \qquad [ Equation 2 ]$$

The emergency step may be determined based on the distance to the object and/or the collision estimated time.

FIG. 13 is an embodiment of a vehicle to which the present disclosure may be applied.

The vehicle senses the surrounding objects through the sensor (S1310). The sensor may be composed of a plurality of sensors, and each sensor may generate

The vehicle determines an emergency step based on the distance to the object, the collision estimated time, and/or the appearance event (S1320). For example, the emergency step may include three steps. When it is determined that the object exists below the predetermined A3m, the emergency step may be determined as a first step. Alternatively, when an object exists below a predetermined A2m, and the appearance event occurs in that the object is an untracked object, the emergency step may be determined as a second step. The appearance event is configured according to whether an object that has not been detected in a previous frame is detected based on a predetermined frame of sensing data. When an object exists below a predetermined Alm and the appearance event of the object occurs, the emergency step may be determined as a third step. This area range may be configured sequentially according to the distance A3>A2>A1. The collision estimated time may be configured and sequentially considered as T3>T2>T1 in a manner similar to the area range for determining the emergency step.

The vehicle transmits the sensing data by the emergency step (S1330). When it is determined that the emergency step is a first step, the vehicle transmits first sensing data. The first sensing data includes sensing data and emergency step information generated by the sensor. When it is determined that the emergency step is a second step, the second sensing data is transmitted. The second sensing data includes sensing data, appearance event, and emergency step information generated by the sensor. When it is determined that the emergency step is a third step, third sensing data is transmitted. The third sensing data includes location information, appearance event, and emergency step information of the object that is the subject of emergency step determination in the sensing data generated by the sensor. That is, in the third step, the vehicle may transmit data smaller than the first step 1 and the second step by transmitting data including only the location information of the object among the sensing data, and the server may quickly generate a control message based on the location information. This allows for immediate response.

The vehicle receives a control message based on the sensing data from the server (S1340).

The vehicle may perform a control operation according to the received control message (S1350).

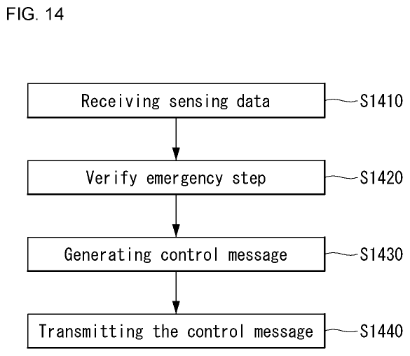

FIG. 14 is an embodiment of a server to which the present disclosure may be applied.

The server receives the sensing data from the vehicle (S1410).

The server may verify whether the emergency step included in the sensing data is valid (S1420). As described above, as the determination of the emergency step is performed based on the distance from the vehicle to the object, the collision estimated time, and/or the appearance event, the server may verify the emergency step by referring to not only senses data that is the subject of the determination in the vehicle but also previously transmitted sensing data. Alternatively, the emergency step may be verified by referring to the sensing data generated for the object from another sensor. For example, when it is determined as the third step in the vehicle, the server may know that it is determined as the third step in the vehicle through the emergency step information included in the third sensing data, and when there is the sensing data generated for the object in another sensor. through the sensing data, it is possible to classify the object, and the object may be determined to be an object that does not pose a danger to driving of the vehicle, or when it may be determined that there is an error in the third sensing data, the emergency step may be determined as an error, and in this case, the sensing data may be received again and a control message may be generated based on the sensing data. This verification process may be performed by the AI processor of the server or by the AI processor of the vehicle, and a deep learning algorithm learned for this may be used.

The server generates a control message for controlling the vehicle (S1430). When it is configured in the third step, the server immediately generates a third control message including an emergency control command (for example, sudden braking or steering wheel control, all transmissions such as V2V, V2P, V2I, and the like, and control level B1).

In the case of emergency step 2, it is classified for which object and second control message is generated including a control command (for example, comfortable brake and handle control, V2X message transmission according to classification, control level B2).

In the case of emergency step 1, it is classified for which object and then by tracking and further predicting which behavior to take and based on the prediction, a first control message is generated including a control command (for example, by the behavior of object).

The server transmits the generated control message to the vehicle (S1440). The vehicle may perform a control operation according to the received control message.

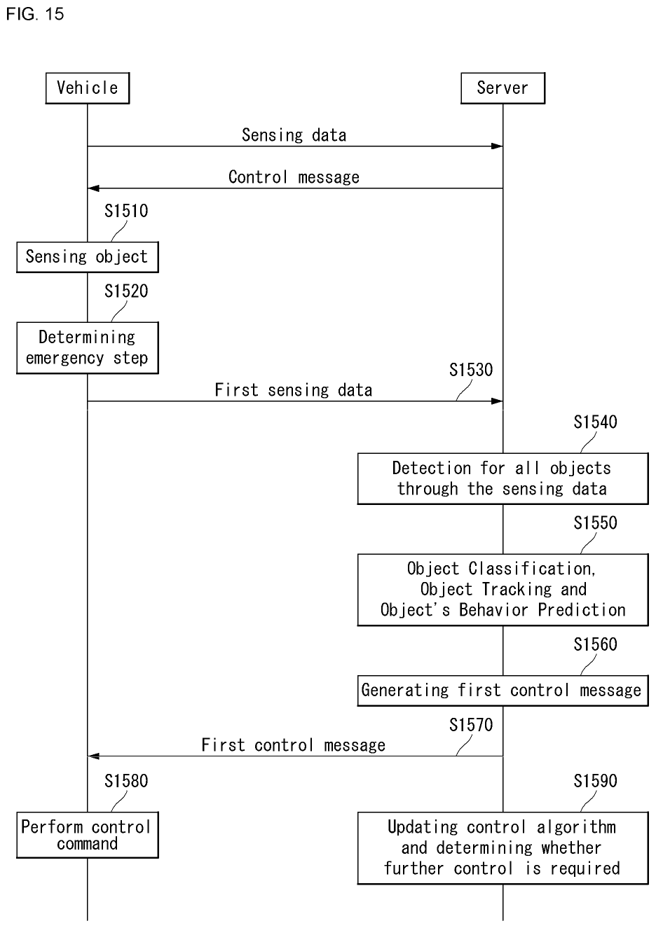

FIG. 15 is an embodiment where the emergency step to which the present disclosure may be applied is the first step.

The vehicle senses the surrounding object through the sensor (S1510).

Based on the sensing data, the emergency step is determined (S1520).

The vehicle transmits the first sensing data to the server (S1530).

When the emergency step is the first step, all objects are detected through the sensing data (S1540).

The server performs classification on which object, for all objects, and then tracks them, to further predict on which behavior to be performed (S1550).

The server generates a first control message including a control command (for example, by the behavior of the object) based on the classified behavior prediction of the object (S1560).

The server may transmit the first control message to the vehicle (S1570).

The vehicle may perform a control operation based on the control command included in the first control message (S1580).

The server may update the control algorithm based on the sensing data received thereafter, and determine whether further control of the vehicle is required (S1590).

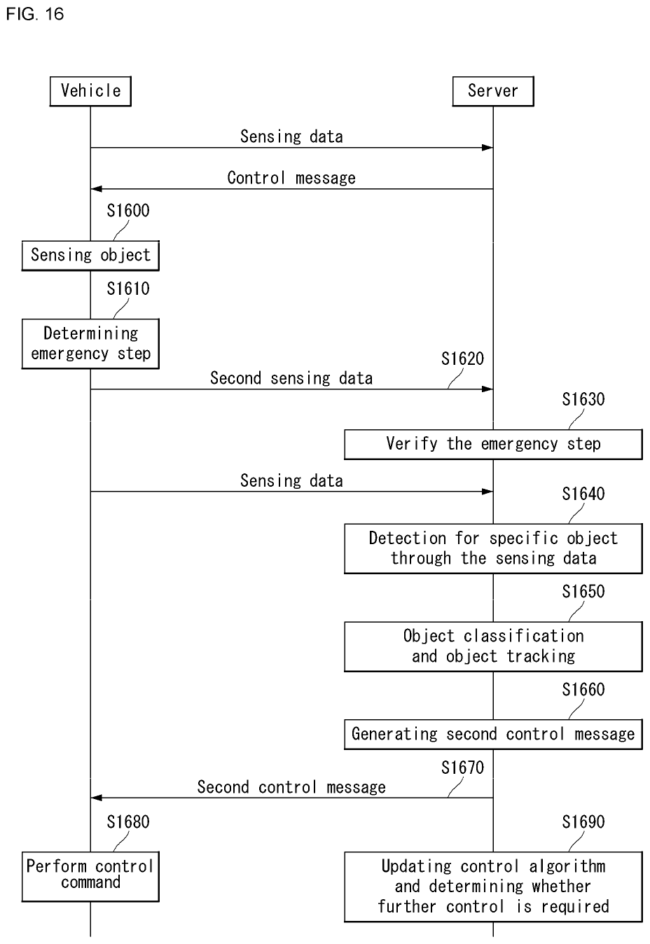

FIG. 16 is an embodiment where the emergency step to which the present disclosure may be applied is the second step.

The vehicle senses the surrounding object through the sensor unit (S1600).

Based on the sensing data, the emergency step is determined (S1610).

When the emergency step is the second step, the vehicle transmits the second sensing data to the server (S1620). The second sensing data includes sensing data, appearance event, and emergency step information generated by the sensor.

The server conducts verification that the vehicle determines the emergency step as the second stage based on the emergency step information (S1630).

The vehicle may periodically transmit sensing data (S1640).

The server detects a specific object associated with the appearance event of the second sensing data, through the sensing data received from the vehicle (S1640).

The server classifies and tracks a specific object (S1650).

The server generates a second control message including a control command based on the tracking result of the classified specific object (S1660).

The server transmits a second control message to the vehicle (S1670).

The vehicle performs a control operation based on the second control message (S1680).

The server may then update the control algorithm based on the received sensing data, and determine whether further control of the vehicle is required (S1690).

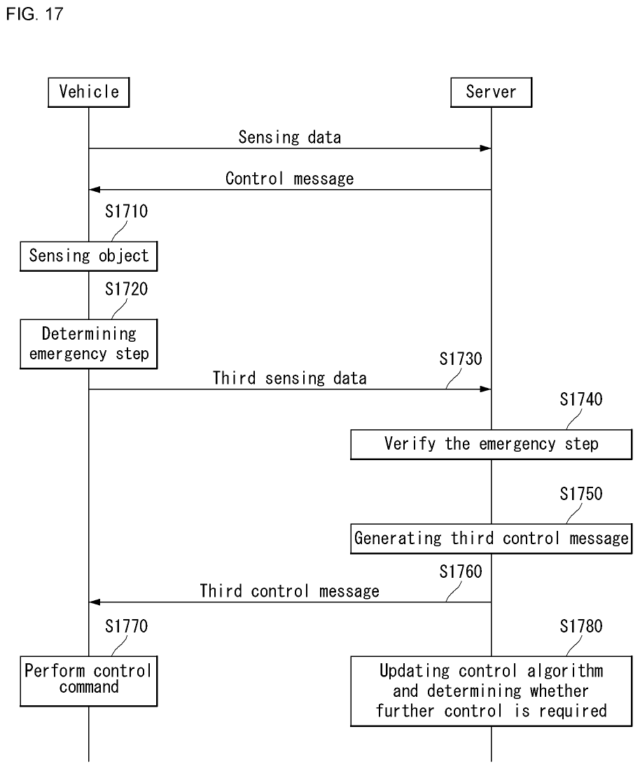

FIG. 17 is an embodiment where the emergency step to which the present disclosure may be applied is the third step.

The vehicle senses the surrounding object through the sensor (S1710).

Based on the sensing data, the emergency step is determined (S1720).

The vehicle transmits the third sensing data to the server (S1730). The third sensing data includes location information, appearance event, and emergency step information of an object that is the subject of emergency step determination.

The server verifies the emergency step determination of the vehicle based on the third sensing data (S1740).

When the determination for the third step of the vehicle is valid, the server generates a third control message (S1750). The server generates a third control message including an emergency control operation without performing an operation such as object classification, tracking, or behavior prediction.

The server transmits a third control message to the vehicle (S1760).

The vehicle performs a control operation based on the third control message (S1770).

The server may update the control algorithm based on the sensing data received thereafter, and determine whether further control of the vehicle is required (S1780).

### Embodiment to which the Present Disclosure May be Applied

### 1. When a Vehicle that is Interrupting from 15 m in the Right and Front of a Vehicle that is Traveling Straight in Front is Found

The vehicle recognizes with radar that there is an object approaching suddenly 15 m in the right and front thereof. The vehicle determines the emergency step as third step, and transmits third sensing data (for example, third step, 15 m, right ahead side, and appearance event) to the server. The server does not perform object detection, object classification, object tracking, etc. based on the third sensing data, and it is possible to determine whether the vehicle is able to move to the left lane through the road information on which the vehicle is traveling and other sensing data, and the distance between the rear vehicle and the vehicle is checked to be 30 m to recognize that the vehicle can be moved to the left lane.

The server changes lanes, generates control command of ringing the horn, and transfers the control command to the vehicle. In addition, the server generates and transfers control commands that transfer collision-associated messages to V2V, V2P, and V2I.

The vehicle controls the vehicle based on the control command received from the server. The server may then performing object detection, object classification, object tracking, and the like based on the sensing data received thereafter, to control performing the following operation.

### 2. When a Vehicle Traveling Straight in Front Identifies a Vehicle Approaching an Intersection

The vehicle traveling straight in front recognizes an object approaching 200 m from the left and front thereof as a radar. The vehicle determines the emergency step as the second step. The vehicle transmits the sensing data to the server. The server receives the sensing data to perform object detection, object classification, and object tracking of the approaching object, and then determines that the vehicle is approaching and a collision may occur 5 seconds later at the current speed (without performing behavior determination and prediction). The server generates a control message that controls the braking torque to reduce the speed to 30 km/h after 3 seconds through the brake system and also generates a second control message that includes a control command to transfer a LTA (Left Turn Assistance) message in the V2V. The vehicle performs a control operation based on the control message received from the server.

### 3. When Other Vehicles Approaching the Rear is Found Upon Entering the Highway

The vehicle determines the emergency step as the first step. The server receives the first sensing data, performs object detection, object classification, and object tracking of all objects to perform behavior determination and prediction, and as the vehicle is approaching and the approaching vehicle changes lanes to the left lane, it is estimated that there is no possibility of collision.

The server maintains the speed at 80 km/h through the acceleration system, entering the lane for 5 seconds after 5 seconds, and generates and transfers a first control message for transferring an IMA (intersection movement assistance) message in V2V. The vehicle performs a control operation based on the received first control message. The server may then confirm, via the received sensing data, that the vehicle that was likely to collide goes straight without changing lanes, thereby further controlling and updating the behavior prediction algorithm

### 4. Other Embodiments

### Embodiment 1

In a method for controlling by an emergency step in a vehicle in the autonomous driving system, the method comprising the steps of:

sensing an object through a sensor; determining an emergency step related the object based on at least one of a distance with the object, a collision estimation time with the object, and an appearance event of the object; and transmitting, to a server, sensing data related to the object based on the emergency step,

wherein the vehicle is remotely controlled through the server, and the appearance event is to indicate that the object is an object not sensed for a predetermined time in the sensor.

### Embodiment 2

In the embodiment 1 of the method for controlling by an emergency step in a vehicle,

wherein the emergency step is classified based on the degree of attention required related to the object, and comprises the step of indicating that the vehicle should immediately perform a control operation relating to the object.

### Embodiment 3

In the embodiment 2 of the method for controlling by an emergency step in a vehicle,

when the emergency step indicates that the vehicle should immediately perform the control operation, the sensing data is composed of location information of the object and information of the emergency step.

### Embodiment 4

In the embodiment 3 of the method for controlling by an emergency step in a vehicle,

further comprising the steps of: receiving, from the server, a control message; and performing a control operation based on the control message; and wherein the control message is generated based on the information of the emergency step in the server

### Embodiment 5

In a method for controlling by an emergency step in a server in the autonomous driving system,

the method comprising the steps of: receiving, from a vehicle, sensing data related to an object; performing an algorithm for detecting the object based on the sensing data; generating a control message based on the algorithm; and transmitting, to the vehicle, the control message,

wherein the server remotely controls the vehicle, and the sensing data includes information of an emergency step, the emergency step is configured in the vehicle and classified based on the degree of attention required related to the object.

### Embodiment 6

In the embodiment 5 of the method for controlling by an emergency step in a server,

wherein the algorithm includes object detection, object classification, object tracking or object behavior prediction

### Embodiment 7

In the embodiment 6 of the method for controlling by an emergency step in a server,

wherein the emergency step includes the step of indicating that a control operation associated with the object should be performed in the vehicle or indicating that the control operation should be performed immediately in the vehicle.

### Embodiment 8

In the embodiment 6 of the method for controlling by an emergency step in a server,

further comprising the step of verifying the emergency step based on stored sensing data or sensing data generated from another sensor, wherein when the verification fails, all of the algorithms are performed.

### Embodiment 9

In the embodiment 7 of the method for controlling by an emergency step in a server,

wherein when the information of the emergency step indicates that the control operation associated with the object should be performed in the vehicle, the algorithm is that the object detection, the object classification, the object tracking and the object behavior prediction is performed.

### Embodiment 10

In the embodiment 9 of the method for controlling by an emergency step in a server,

wherein the object detection is to detect the object only.

### Embodiment 11

In the embodiment 7 of the method for controlling by an emergency step in a server,

wherein when the information of the emergency step indicates that the control operation should be immediately performed in the vehicle, the algorithm is that the object detection is performed.

### Embodiment 12

In the embodiment 11 of the method for controlling by an emergency step in a server,

wherein the control message is for causing the control operation to be immediately performed in the vehicle.

### Embodiment 13

In a server for performing by an emergency step in the autonomous driving system, comprising: a transceiver; a memory; and a processor,

wherein the processor configured to: receive, from a vehicle, sensing data related to an object through the transceiver; perform an algorithm for detecting the object based on the sensing data; generate a control message based on the algorithm; and transmit, to the vehicle, the control message via the transceiver, wherein the server remotely controls the vehicle, and the sensing data includes information of an emergency step, the emergency step is configured in the vehicle and classified based on the degree of attention required related to the object.

### Embodiment 14

In the embodiment 13 of the server,

wherein the algorithm includes object detection, object classification, object tracking or object behavior prediction.

### Embodiment 15

In the embodiment 14 of the server,

wherein the emergency step includes the step of indicating that a control operation associated with the object should be performed in the vehicle or indicating that the control operation should be performed immediately in the vehicle.

### Embodiment 16

In the embodiment 14 of the server,

wherein the processor further configured to verify the emergency step based on the sensing data stored on the memory or sensing data generated from another sensor, wherein when the verification fails, all of the algorithms are performed.

### Embodiment 17

In the embodiment 15 of the server,

wherein when the information of the emergency step indicates that the control operation associated with the object should be performed in the vehicle, the algorithm is that the object detection, the object classification, the object tracking and the object behavior prediction is performed.

### Embodiment 18

In the embodiment 17 of the server,

wherein the object detection is to detect the object only.

### Embodiment 19

In the embodiment 15 of the server,

wherein when the information of the emergency step indicates that the control operation should be immediately performed in the vehicle, the algorithm is that the object detection is performed.

### Embodiment 20

In the embodiment 19 of the server,

wherein the control message is for the control operation to be performed immediately in the vehicle.

General Apparatus to which the Present Disclosure can be Applied

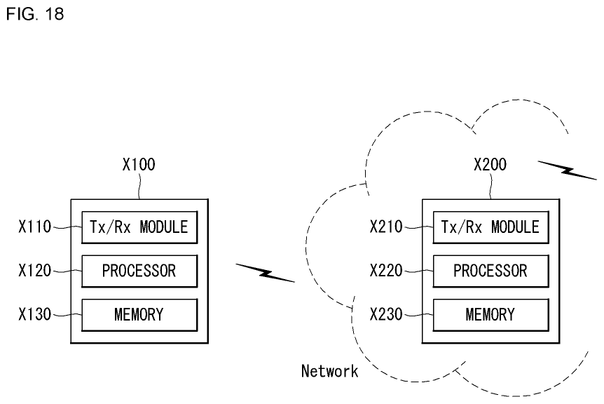

Referring to FIG. 18, the server X200 may be a MEC server or a cloud server, and may include a communication module X210, a processor X220, and a memory X230. The communication module X210 may also be referred to as a radio frequency (RF) unit. The communication module X210 may be configured to transmit various signals, data and information to an external device and to receive various signals, data and information from an external device. The server X200 may be connected to an external device by wire and/or wirelessly. The communication module X210 may be implemented by being separated into a transmitter and a receiver. The processor X220 may control the overall operation of the server X200, and may be configured to perform a function of computing and processing information to be transmitted/received with an external device. In addition, the processor X220 may be configured to perform a server operation proposed in the present disclosure. The processor X220 may control the communication module X210 to transmit data or a message to a UE, another vehicle, or another server according to the proposal of the present disclosure. The memory X230 may store the processed information and the like for a predetermined time and may be replaced with a component such as a buffer.

In addition, specific configurations of the terminal device (X100) and the server (X200) as described above, may be implemented so that the above-described matters described in various embodiments of the present disclosure can be applied independently or two or more embodiments are applied at the same time, the duplicated descriptions is omitted for clarity.

The above-described present disclosure can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Furthermore, although the invention has been described with reference to the exemplary embodiments, those skilled in the art will appreciate that various modifications and variations can be made in the present disclosure without departing from the spirit or scope of the invention described in the appended claims. For example, each component described in detail in embodiments can be modified. In addition, differences associated with such modifications and applications should be interpreted as being included in the scope of the present disclosure defined by the appended claims.

Although description has been made focusing on examples in which the present disclosure is applied to automated vehicle & highway systems based on 5G (5 generation) system, the present disclosure is also applicable to various wireless communication systems and autonomous driving devices.

What is claimed is:

1. A method for controlling by an emergency step in a vehicle in the autonomous driving system, the method comprising the step of:
sensing an object through a sensor:
determining an emergency step related the object based on at least one of a distance with the object, a collision estimation time with the object, and an appearance event of the object; and
transmitting, to a server, sensing data related to the object based on the emergency step,
wherein the vehicle is remotely controlled through the server and the appearance event is to indicate that the object is an object not sensed for a predetermined time in the sensor.

2. The method of claim 1, wherein the emergency step is classified based on the degree of attention required related to the object, and
comprises the step of indicating that the vehicle should immediately perform a control operation relating to the object.

3. The method of claim 2, when the emergency step indicates that the vehicle should immediately perform the control operation, the sensing data is composed of location information of the object and information of the emergency step.

4. The method of claim 3, further comprising the steps of:
receiving, from the server, a control message; and
performing a control operation based on the control message; and
wherein the control message is generated based on the information of the emergency step in the server

5. A method for controlling by an emergency step in a server in the autonomous driving system, the method comprising the step of:
receiving, from a vehicle, sensing data related to an object;
performing an algorithm for detecting the object based on the sensing data;
generating a control message based on the algorithm; and
transmitting, to the vehicle, the control message,
wherein the server remotely controls the vehicle, and the sensing data includes information of an emergency step, the emergency step is configured in the vehicle and classified based on the degree of attention required related to the object.

6. The method of claim 5, wherein the algorithm includes object detection, object classification, object tracking or object behavior prediction.

7. The method of claim 6, wherein the emergency step includes the step of indicating that a control operation associated with the object should be performed in the vehicle or indicating that the control operation should be performed immediately in the vehicle.

8. The method of claim 6, further comprising the step of verifying the emergency step based on stored sensing data or sensing data generated from another sensor,
wherein when the verification fails, all of the algorithms are performed.

9. The method of claim 7, wherein when the information of the emergency step indicates that the control operation associated with the object should be performed in the vehicle, the algorithm is that the object detection, the object classification, the object tracking and the object behavior prediction is performed.

10. The method of claim 9, wherein the object detection is to detect the object only.

11. The method of claim 7, wherein when the information of the emergency step indicates that the control operation should be immediately performed in the vehicle, the algorithm is that the object detection is performed.

12. The method of claim 11, wherein the control message is for causing the control operation to be immediately performed in the vehicle.

13. A server for performing by an emergency step in the autonomous driving system, comprising:
a transceiver;
a memory; and
a processor,
wherein the processor configured to:
receive, from a vehicle, sensing data related to an object through the transceiver;
perform an algorithm for detecting the object based on the sensing data;
generate a control message based on the algorithm; and
transmit, to the vehicle, the control message via the transceiver,
wherein the server remotely controls the vehicle, and the sensing data includes information of an emergency step, the emergency step is configured in the vehicle and classified based on the degree of attention required related to the object.

14. The sever of claim 13, wherein the algorithm includes object detection, object classification, object tracking or object behavior prediction.

15. The sever of claim 14, wherein the emergency step includes the step of indicating that a control operation associated with the object should be performed in the vehicle or indicating that the control operation should be performed immediately in the vehicle.

16. The sever of claim 14, wherein the processor further configured to verify the emergency step based on the sensing data stored on the memory or sensing data generated from another sensor,
wherein when the verification fails, all of the algorithms are performed.

17. The sever of claim 15, wherein when the information of the emergency step indicates that the control operation associated with the object should be performed in the vehicle, the algorithm is that the object detection, the object classification, the object tracking and the object behavior prediction is performed.

18. The sever of claim 17, wherein the object detection is to detect the object only.

19. The sever of claim 15, wherein when the information of the emergency step indicates that the control operation should be immediately performed in the vehicle, the algorithm is that the object detection is performed.

20. The method claim 1, further comprising the step of performing an initial access procedure with a network in which the server is included based on a synchronization signal block (SSB),
wherein the sensing data related to the object is transmitted via a PUSCH through the network to the server through, and
a DM-RS of the PUSCH of the SSB are quasi-co-located (QCLed) for a QCL type D.
